(19) United States
(12) Patent Application Publication
(10) Pub. No.: US 2004/0258806 A1
(43) Pub. Date: Dec. 23, 2004

(54) Methods for making Bulgur food articles and products thereof

(76) Inventor: Chris Khazaal, Las Vegas, NV (US)

Correspondence Address: WEISS & MOY PC, 4204 NORTH BROWN AVENUE, SCOTTSDALE, AZ, 85251, US

(21) Appl. No.: 10/601,114

(22) Filed: Jun. 23, 2003

(51) Int. Cl. A23G 1/00

(52) U.S. Cl. 426/104

(57) ABSTRACT

Methods for making Bulgur food articles and products thereof are disclosed. The food articles comprise an outer shell formed by mixing and grinding a mixture of Bulgur, raw meat, seasonings and an edible fluid. The outer shell is formed into a pre-determined configuration. Examples of configurations include a miniature football, a hamburger, a cookie, a hot dog, a sausage, an egg and a ball. A filling is formed by mixing and pre-cooking a mixture of raw meat, onion, seasonings and nuts. The filling is located within the outer shell. The food articles are packaged and frozen for further use or immediately cooked using edible oil.

### FIELD OF THE INVENTION

This invention relates generally to methods for making filled food articles and derived products, and more specifically to methods for making Bulgur food articles and products thereof.

### BACKGROUND OF THE INVENTION

In the past, numerous articles and methods were used for making filled food articles. Such food articles were available in pre-packaged forms and were in cooked, partially cooked or uncooked form. The convenience associated with pre-packaged food articles was a basis for their increasing use by consumers. Typically, the taste of such food articles was somewhat lacking compared to freshly prepared food articles.

Many different types of binders form the basis of food articles that are in the form of shells stuffed with fillers. Examples of binders include potato, rice and flour mixtures. Bulgur is an ancient wheat food of Near Eastern origin, offering whole grain nutrition, high carbohydrate content to supply energy and low fat content. Bulgur is referred to as “Arisah” in the Old Testament and is variously known as Bulgur, Boulgor, Bulgor, Brughoul and Burghoul. Bulgur is the common name given in North America for a hard (durum) cracked wheat which has been steamed, dried, then crushed into a fine, medium or coarse grind. Bulgur is an increasingly popular side dish and offers binding properties similar to potato rice and flour.

Kerkorian U.S. Pat. No. 5,246,721 discloses a method and apparatus for forming a food article. The food article described in Kerkorian is a shell made with finely ground meat that is molded in an apparatus and stuffed with a filler consisting of seasoned coarsely ground meat-with the binder being Bulgur wheat and pine nuts. Alternatively, the binder can include vegetables and rice, or the shell can be filled without any meat. The entire food article described as Kibbe is made in situ in the apparatus, and is cooked later in its entirety.

Although a Bulgar food article that is filled can be made as described in Kerkorian, according to Kerkorian the shell and filling are cooked together. The inventor of this patent application has discovered that it is much more desirable to pre-cook the filling and dispense it into the shell. This method is not disclosed, suggested or comprehended by Kerkorian.

For the foregoing reasons, a need exists for improved methods for making Bulgur food articles and products thereof. The present invention provides Bulgur food articles in which a shell is formed and to which a pre-cooked filling is added. Bulgur food articles may then be fully cooked or packaged and frozen for later cooking. This provides a means for mass-merchandising Bulgur food articles that are filled. Bulgur food articles formed in this manner provides convenience for a consumer. In addition, the shells of Bulgur food articles may be shaped into various forms so that these food articles provide novelty foods or can be used in place of conventional foods.

### SUMMARY OF THE INVENTION

It is an object of the present invention to provide improved methods for making Bulgur food articles.

It is a further object of the present invention to provide improved methods for making partially pre-cooked Bulgur food articles.

It is a still further object of the present invention to provide improved methods of storing partially pre-cooked Bulgur food articles by packaging and freezing for later use.

It is a still further object of the present invention to provide improved partially pre-cooked Bulgur food articles that are in pre-determined configurations.

### BRIEF DESCRIPTION OF THE PREFERRED EMBODIMENTS

In accordance with an embodiment of the present invention, a method for making a Bulgur food article is disclosed. The method comprises the steps of providing an uncooked mixture comprising Bulgur; providing an outer shell formed from the mixture, the shell having a pre-determined configuration; and providing an edible pre-cooked filling for the Bulgur food article located within the outer shell, the uncooked mixture comprising Bulgur when cooked with the edible pre-cooked filling providing a combination cooked product.

The method further comprises providing the uncooked mixture comprising Bulgur and an edible fluid; grinding the uncooked mixture at least one time; decanting off excess of the edible fluid; and configuring the uncooked mixture into a shaped outer shell for receiving the edible pre-cooked filling. The method further comprises providing an uncooked filling; blending the uncooked filling; pre-cooking the uncooked filling making the edible pre-cooked filling; and locating the edible pre-cooked filling within the outer shell. The uncooked filling is pre-cooked for at least 5 minutes at a temperature of at least 177° C. The method further comprises packaging and freezing the Bulgur food article; and cooking the frozen Bulgur food article for at least 15 minutes at a temperature of at least 177° C. making the combination cooked product. Alternatively, the method further comprises cooking the Bulgur food article for at least 5 minutes at a temperature of at least 177° C. making the combination cooked product.

The mixture comprises at least Bulgur, a raw meat, a plurality of seasonings and an edible fluid. The raw meat of the mixture is selected from the group consisting of beef, lamb, pork, poultry, venison and rabbit. The edible fluid comprises water. Alternatively, the edible fluid comprises a broth. The ratio by weight of Bulgur to raw meat to fluid is from 4:1:4 to 1:2:1 and more preferably 1:1:1. The pre-determined configuration of the Bulgur mixture outer shell is selected from the group consisting of a miniature football, a hamburger, a cookie, a hot dog, a sausage, an egg and a ball.

The uncooked filling comprises ingredients selected from the group consisting of vegetables, seafood, raw meat, onion, a plurality of seasonings and nuts. The raw meat of the uncooked filling is selected from the group consisting of beef, lamb, pork, poultry, venison and rabbit. The nuts are selected from the group consisting of peas, beans, chick peas, peanuts, pecans, almonds and walnuts. The ratio by weight of raw meat to onions to nuts is from 8:2:1 to 4:2:1 and more preferably 2:2:1.

A Bulgur food article prepared by the method is disclosed.

The foregoing and other objects, features, and advantages of the invention will be apparent from the following, more particular, description and drawings of the preferred embodiments of the invention.

### BRIEF DESCRIPTION OF THE DRAWINGS

FIG. 1 is a perspective view of a Bulgur food article in the shape of a miniature football and side vegetables on a plate in accordance with this invention;

FIG. 2 is a cross-sectional elevation view through 2-2 of the miniature football shaped filled Bulgur food article of FIG. 1;

FIG. 3 is a cross-sectional elevation view through 2-2 of the miniature football shaped unfilled Bulgur food article of FIG. 1;

FIG. 4 is a perspective view of a second example of a Bulgur food article in the shape of a hamburger or a cookie;

FIG. 4A is a cross-sectional elevation view through 4-4 of the hamburger or cookie shaped Bulgur food article of FIG. 4;

FIG. 5 is a perspective view of a third example of a Bulgur food article in the shape of a hot dog or sausage;

FIG. 6 is a perspective view of a fourth example of a Bulgur food article in the shape of an egg; and

FIG. 7 is a perspective view of a fifth example of a Bulgur food article in the shape of a ball;

### DESCRIPTION OF THE INVENTION

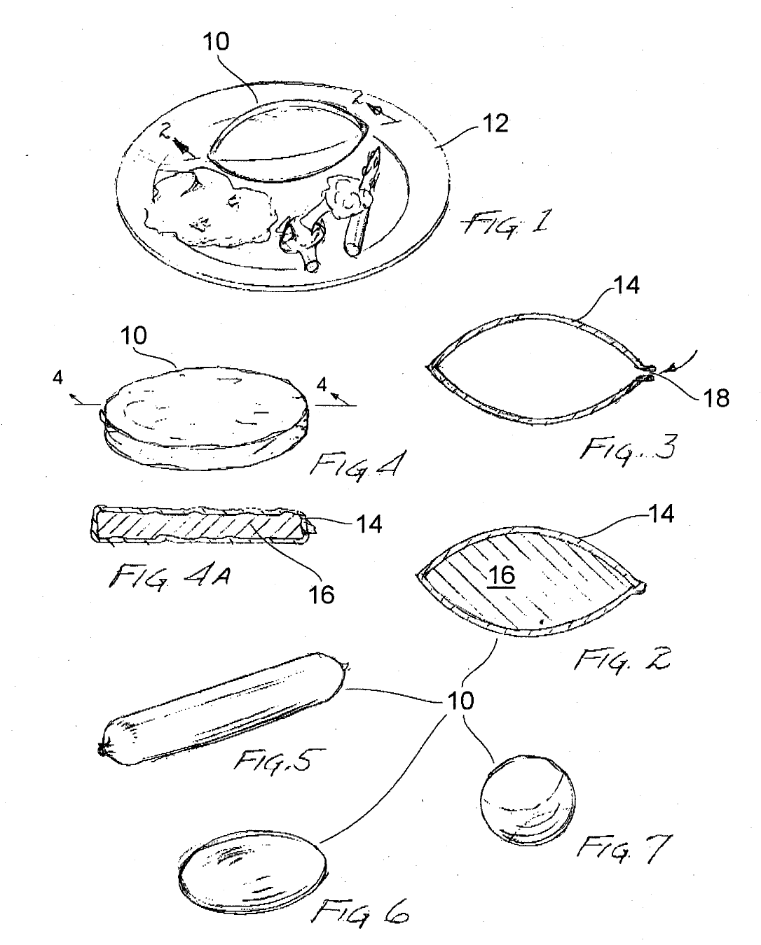

Referring to FIG. 1, a Bulgur food article 10 in the shape of a miniature football is provided on a plate 12 accompanied with a number of side vegetables. The plate presentation shows a complete entree for a consumer. For a consumer that has a great interest in football, the plate presentation is of great novelty.

FIGS. 2 and 3 are cross-sectional elevation views of the miniature football shaped Bulgur food article 10. In FIG. 2 the miniature football Bulgur food article 10 comprises an outer shell 14 enclosing a filling 16. FIG. 3 illustrates the miniature football shaped Bulgur food article 10 without the filling 16. The outer shell 14 defines an opening 18 of a portion of the outer shell. Preferably the diameter of the opening 18 is from 1 to 1.5 inches (2.5 to 3.7 cm). The filling 16 is dispensed through the opening 18 to form the filled miniature shaped Bulgur food article 10. While the opening 18 is shown as being at an end of the outer shell 14, it is understood that the opening 18 may be in another portion of the outer shell 14.

FIG. 4 is a perspective view of a second example of a Bulgur food article 10 shaped as a hamburger or a cookie. The hamburger or cookie shaped Bulgur food article 10 can be used in place of a conventional hamburger as an entree. FIG. 4A is a cross-sectional elevation view of the hamburger or cookie shaped Bulgur food article 10 comprising an outer shell 14 and a filling 16 enclosed by the outer shell 14.

FIGS. 5, 6 and 7 are perspective views of third, fourth and fifth examples of a Bulgur food article 10 that are shaped respectively as a hot dog or sausage, egg and ball. Each of these shapes offers a novel shape to be presented as an entree food that may replace a conventional food item.

A method for making each one of these Bulgur food items is as follows:

The outer shell 14 comprises a mixture of fine ground Bulgur (distributed by Kradjian Importing Co., Inc., Glendale, Calif., U.S.A.), raw meat, seasonings and an edible fluid. Equivalent grades of Bulgur may also be obtained from other sources. The mixture is ground at least once to blend all ingredients. The raw meat is selected from the group consisting of beef, lamb, pork, poultry, venison and rabbit. Poultry includes turkey, chicken and other birds. Seasonings may include salt, pepper, paprika and others that are used as flavor enhancers in cooking. The edible fluid is water or a broth. A preferred mixture for the outer shell 14 comprises 1 pound (454 grams) of Bulgur, 1 pound (454 grams) of raw meat, seasonings to taste, and 1 pound (454 grams) of an edible fluid (water or broth). It is to be understood that the mixture may be scaled up for larger batches. Other acceptable ranges for BuIgur to raw meat to an edible fluid are from 1:2:1 to 4:1:4 by weight. Typically, the Bulgur absorbs most of the edible fluid. Excess edible fluid is decanted from the mixture. The processed outer shell mixture is kept to a consistency that is sufficiently pliable to be able to form a predetermined configuration, which will not collapse because the outer shell is too dry. The shell is formed into the required configuration, leaving an opening 18 for a filling 16.

The uncooked filling 16 comprises a mixture of raw meat, onion, seasoning and nuts. Any raw meat and seasoning as described above is suitable. In addition, fish or other seafood may be substituted for meat and other vegetables may also be added. Preferred nuts are pine nuts but may also include peas, beans, chick peas, peanuts, pecans, almonds and walnuts. It is to be understood that other nuts may also be used. A preferred mixture for filling comprises 1 pound (454 grams) of meat, (454 grams) of onion and 0.5 pound (227 grams) of nuts with seasoning added to taste. It is to be understood that the mixture may be scaled up for larger batches. Other acceptable ranges for meat to onion to nuts are from 4:2:1 to 8:2:1 by weight. The filling mixture is blended and pre-cooked with a vegetable oil, margarine or butter for at least 5 minutes at 350° F. (177° C.).

The cooked filling 16 is dispensed into the interior of the pre-shaped outer shell 14 through the opening 18. The opening 18 in the outer shell 14 is closed off. It is to be understood that other methods of enclosing the cooked filling 16 within the outer shell 14 may be used. The Bulgar food article 10 is packaged and frozen for future cooking. The frozen Bulgar food article 10 may be defrosted prior to cooking or cooked directly without being defrosted. When cooked from frozen, the Bulgar food article 10 is cooked for at least 15 minutes at 350° F. (177° C.). Alternatively, the Bulgar food article 10 is not frozen and is immediately fully cooked using edible oil (preferably vegetable oil) for at least 5 minutes at 350° F. (177° C.). The finished Bulgar food article 10 is brown and glossy in appearance. After fully cooking the Bulgar food article 10 is ready for consumption.

In summary, methods for making Bulgur food articles and products thereof are disclosed. The Bulgur food articles comprise an outer shell formed by mixing and grinding a mixture of Bulgur, raw meat, seasonings and an edible fluid. The outer shell is formed into a pre-determined configuration. Examples of configurations include a miniature football, a hamburger, a cookie, a hot dog, a sausage, an egg and a ball. A filling is formed by mixing and pre-cooking a mixture of raw meat, onion, seasonings and nuts. The filling is located within the outer shell. The Bulgur food articles are packaged and frozen for further use or immediately cooked using edible oil.

While the invention has been particularly shown and described with reference to preferred embodiments thereof, it will be understood by those skilled in the art that the foregoing and other changes in form and details may be made therein without departing from the spirit and scope of the invention. For example, cooking may be done by baking, frying, grilling, broiling or using a microwave. Cooking time may vary depending on the cooking method used. The appearance of the finished Bulgur food articles may be slightly different for each cooking method. Other shapes that enclose a filling can be made. The meat used may be pre-ground. Mixtures of meats may be used. Various grades of Bulgur ranging from fine to coarse may be used.

What is claimed is:

1. A method for making a Bulgur-food article comprising the steps of:
providing an uncooked mixture comprising Bulgur;
providing an outer shell formed from said mixture, said shell having a pre-determined configuration; and
providing an edible pre-cooked filling for said Bulgur food article located within said outer shell, said uncooked mixture comprising Bulgur when cooked with said edible pre-cooked filling providing a combination cooked product.

2. The method for making a Bulgur food article according to claim 1 further comprising the steps of:
providing said uncooked mixture comprising Bulgur and an edible fluid;
grinding said uncooked mixture at least one time;
decanting off excess of said edible fluid; and
configuring said uncooked mixture into a shaped outer shell for receiving said edible pre-cooked filling.

3. The method for making a Bulgur food article according to claim 1 further comprising the steps of:
providing an uncooked filling;
blending said uncooked filling;
pre-cooking said uncooked filling making said edible pre-cooked filling; and
locating said edible pre-cooked filling within said outer shell.

4. The method for making a Bulgur food article according to claim 3 wherein said uncooked filling is pre-cooked for at least 5 minutes at a temperature of at least 177° C.

5. The method for making a Bulgur food article according to claim 1 further comprising the steps of:
packaging and freezing said Bulgur food article; and
cooking the frozen Bulgur food article for at least 15 minutes at a temperature of at least 177° C. making said combination cooked product.

6. The method for making a Bulgur food article according to claim 1 further comprising the step of cooking the Bulgur food article for at least 5 minutes at a temperature of at least 177° C. making said combination cooked product.

7. The method for making a Bulgur food article according to claim 1 wherein said mixture comprises at least Bulgur, a raw meat, a plurality of seasonings and an edible fluid.

8. The method for making a Bulgur food article according to claim 7 wherein the raw meat is selected from the group consisting of beef, lamb, pork, poultry, venison and rabbit.

9. The method for making a Bulgur food article according to claim 7 wherein said edible fluid comprises water.

10. The method for making a Bulgur food article according to claim 7 wherein said edible fluid comprises a broth.

11. The method for making a Bulgur food article according to claim 7 wherein the ratio by weight of Bulgur to raw meat to fluid is from 4:1:4 to 1:2:1 and more preferably 1:1:1.

12. The method for making a Bulgur food article according to claim 1 wherein the pre-determined configuration of said Bulgur mixture outer shell is selected from the group consisting of a miniature football, a hamburger, a cookie, a hot dog, a sausage, an egg and a ball.

13. The method for making a Bulgur food article according to claim 3 wherein said uncooked filling comprises ingredients selected from the group consisting of vegetables, seafood, raw meat, onion, a plurality of seasonings and nuts.

14. The method for making a Bulgur food article according to claim 13 wherein said raw meat is selected from the group consisting of beef, lamb, pork, poultry, venison and rabbit.

15. The method for making a Bulgur food article according to claim 13 wherein said nuts are selected from the group consisting of peas, beans, chick peas, peanuts, pecans, almonds and walnuts.

16. The method for making a Bulgur food article according to claim 13 wherein the ratio by weight of raw meat to onions to nuts is from 8:2:1 to 4:2:1 and more preferably 2:2:1.

17. A Bulgur food article prepared by the method according to claim 1.
